(19) United States
(12) Patent Application Publication
(10) Pub. No.: US 2016/0152175 A1
(43) Pub. Date: Jun. 2, 2016

(54) LIGHT SOURCE MODULE AND LIGHTING DEVICE INCLUDING THE SAME

(71) Applicant: SAMSUNG ELECTRONICS CO., LTD., Suwon-si (KR)

(72) Inventors: Hyung Chan HWANG, Suwon-si (KR); Sun Ki KIM, Suwon-si (KR)

(21) Appl. No.: 14/842,401

(22) Filed: Sep. 1, 2015

(30) Foreign Application Priority Data
Nov. 27, 2014 (KR) 10-2014-0167231

(51) Int. Cl. B60Q 1/38; F21K 99/00; F21S 8/10; G02B 26/10; F21S 10/06

(52) U.S. Cl. CPC B60Q 1/387; G02B 26/105; F21S 10/06; F21S 48/215; F21S 48/24; F21K 9/58; F21W 2101/12

(57) ABSTRACT

A light source module includes a light source, a reflector reflecting light emitted by the light source, and a display on which the light reflected by the reflector is incident, spreading the light in a location on which the light is incident. A position of the location of the display on which light is incident continuously moves in at least one direction according to a motion of the reflector.

### CROSS-REFERENCE TO RELATED APPLICATION

This application claims the priority and benefit of Korean Patent Application No. 10-2014-0167231 filed on Nov. 27, 2014, with the Korean Intellectual Property Office, the disclosure of which is incorporated herein by reference.

### BACKGROUND

The present inventive concept relates to alight source module and a lighting device including the same.

As light-emitting diodes (LEDs) are applied to a vehicle headlamp as light sources, a variety of designs may be allowed for, as compared to the case of existing light sources, and there is growing consumer demand for greater originality in the design of vehicle headlamps.

Conventional turn signal lamps have implemented blinking operations simply using a bulb or an LED. Recently, turn signal lamps have been provided with the image of moving light, using a method of sequentially turning plurality of LEDs arranged in a linear manner on and off.

However, when a failure occurs in one of such a plurality of linearly arranged LEDs, it may be necessary to replace the entire lamp. Accordingly, costs may increase due to use of such a plurality of LEDs. In addition, the quality of illumination may be degraded due to a partial failure of LEDs.

### SUMMARY

An aspect of the present inventive concept may provide a method of overcoming problems caused by using a plurality of LEDs.

According to an aspect of the present inventive concept, a light source module may include a light source, a reflector reflecting light emitted by the light source, and a display on which the light reflected by the reflector is incident, spreading the light in a location on which the light is incident. A position of the location of the display on which light is incident, may continuously move in at least one direction according to a motion of the reflector.

The spread light may have a pattern of moving in a direction along the display.

The reflector may implement a predetermined signal by allowing the display to repeatedly display the pattern in predetermined cycles.

A speed and a direction of the light, of the light source, moving along the display may be controlled by a rotational speed and a rotational direction of the reflector.

The display may have a structure convexly protruding in an advancing direction of the light.

The display may be semitransparent or non-transparent and include a light-spreading material.

The reflector may have a rotational axis in a direction perpendicular to an optical axis of the light source and rotate in a clockwise or counter-clockwise direction with respect to the light source.

The reflector may include a first plane and a second plane disposed opposite to the first plane and reflect the light emitted by the light source through the first plane and the second plane.

The light source may include a semiconductor light-emitting device emitting light having linearity.

The light source may include a package body having a recess, an LED chip mounted in the recess, a wavelength conversion layer filling the recess and encapsulating the LED chip, and a lens disposed on the LED chip.

The light source module may further include a driver driving the reflector to rotate.

The light source may be the only light source emitting the light that is reflected by the reflector.

According to another aspect of the present inventive concept, a light source module may include a light source emitting light having linearity, a display on which the light emitted by the light source is incident, spreading the light in a location on which the light is incident, and a reflector disposed on a path of light to have a rotational structure and reflecting the light emitted by the light source to the display. A motion of the reflector may be controlled to implement a pattern of an image in which the light incident on the display moves in at least one direction along the display.

A moving pattern of the light moving along the display may be repeatedly displayed in predetermined cycles, and the cycle, a moving speed, and a moving direction may be controlled by a rotational speed and a rotational direction of the reflector.

The light source may be the only light source emitting the light that is reflected by the reflector.

According to another aspect of the present inventive concept, a lighting device may include a light source module, a housing accommodating the light source module therein, and a cover installed on the housing and covering the light source module.

The cover may partially include a display of the light source module.

According to still another aspect of the present inventive concept, a light source module may include a display including a plurality of regions arranged in one direction, and a rotatable reflector receiving light emitted by a single light source, and reflecting the received light to the display. The plurality of regions of the display may be sequentially illuminated along the one direction by the reflected light in accordance with rotation of the rotatable reflector.

Each of the plurality of regions may spread the reflected light incident thereto.

A moving pattern of the light moving along the display may be repeatedly displayed in predetermined cycles, and the cycle, a moving speed, and a moving direction are controlled by a rotational speed and a rotational direction of the reflector.

### BRIEF DESCRIPTION OF DRAWINGS

The above and other aspects, features and advantages of the present inventive concept will be more clearly understood from the following detailed description taken in conjunction with the accompanying drawings, in which:

FIG. 1 is a perspective view schematically illustrating a light source module according to an exemplary embodiment of the present inventive concept;

FIG. 2A is a plan view of FIG. 1, and FIG. 2B is a front view schematically illustrating a state in which spread light moves along a display of FIG. 2A;

FIGS. 3A and 3B are a perspective view and a cross-sectional view schematically illustrating a modified example of a display in the light source module of FIG. 1, respectively;

FIG. 4 is a perspective view schematically illustrating an exemplary embodiment of a light source of the light source module of FIG. 1;

FIG. 5 is a cross-sectional view of FIG. 4;

FIGS. 6A and 6B are a plan view and a cross-sectional view schematically illustrating a package body of the light source of FIG. 4;

FIG. 7 is the CIE 1931 coordinate system, illustrating coordinates of a wavelength conversion material according to an exemplary embodiment of the present inventive concept;

FIGS. 8 to 10 are cross-sectional views illustrating various examples of an LED chip utilized as a light source;

FIG. 11 is a perspective view schematically illustrating a lighting device (a headlamp) according to an exemplary embodiment of the present inventive concept;

FIG. 12 is a plan view schematically illustrating a light source module of FIG. 11;

FIGS. 13A to 13C are front views schematically illustrating states in which spread light moves along a display of FIG. 12;

FIG. 14 is a perspective view schematically illustrating a lighting device (a traffic light) according to an exemplary embodiment of the present inventive concept;

FIG. 15 is a perspective view schematically illustrating a light source module of FIG. 14;

FIGS. 16A to 16C are front views schematically illustrating states in which spread light moves along a display of FIG. 15;

FIG. 17 is a front view schematically illustrating a lighting device (an electronic signboard) according to an exemplary embodiment of the present inventive concept;

FIG. 18 is a perspective view schematically illustrating a light source module of FIG. 17; and

FIGS. 19A to 19C are front views schematically illustrating states in which spread light moves along a display of FIG. 18.

### DETAILED DESCRIPTION

Various embodiments will now be described more fully with reference to the accompanying drawings in which some embodiments are shown. The present disclosure may, however, be embodied in different forms and should not be construed as limited to the embodiments set forth herein. Rather, these embodiments are provided so that this disclosure is thorough and complete and fully conveys the present disclosure to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an embodiment can be implemented differently, functions or operations described in a particular block may occur in a different way from a flow described in the flowchart. For example, two consecutive blocks may be performed simultaneously, or the blocks may be performed in reverse according to related functions or operations.

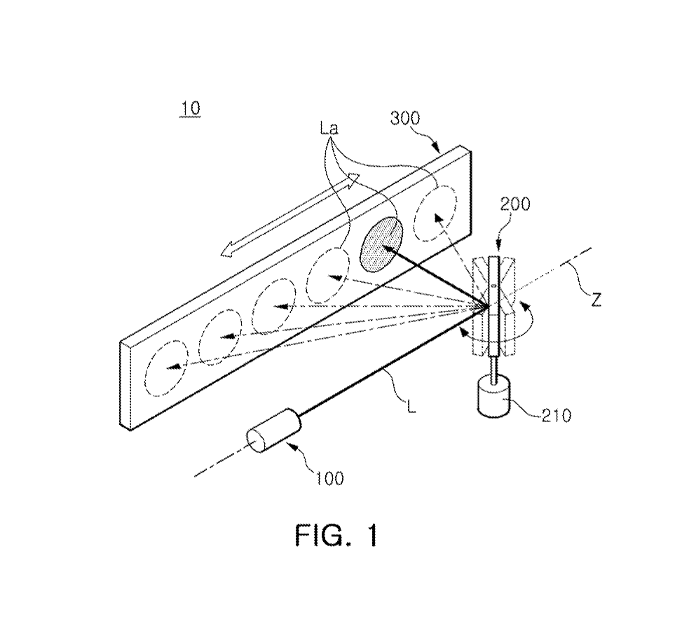

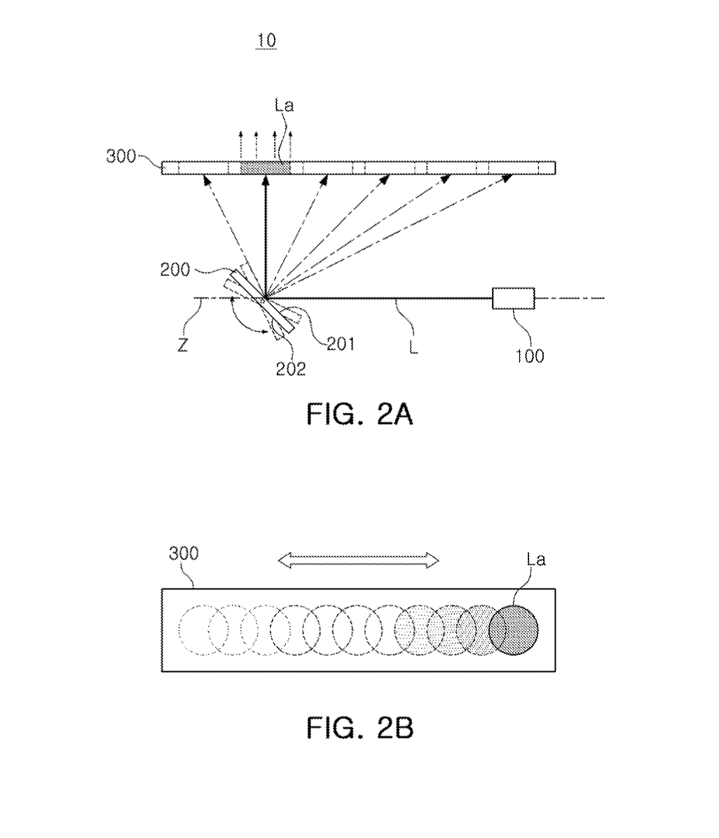

A light source module according to an exemplary embodiment of the present inventive concept will be described with reference to FIGS. 1 and 2. FIG. 1 is a perspective view schematically illustrating a light source module according to an exemplary embodiment of the present inventive concept, FIG. 2A is a plan view of FIG. 1, and FIG. 2B is a front view schematically illustrating a state in which spread light moves along a display of FIG. 2A.

Referring to FIG. 1 and FIGS. 2A and 2B, a light source module 10 according to an exemplary embodiment of the present inventive concept may include a light source 100, a reflector 200, and a display 300.

The light source 100 may emit light L having a predetermined wavelength when power from an external device is supplied. The light source 100 may include, for example, a semiconductor light-emitting device emitting light having linearity and a high degree of luminance.

The semiconductor light-emitting device may include, for example, a light-emitting diode (LED) chip including an n-type semiconductor layer, a p-type semiconductor layer, and active layer disposed therebetween, and may have a package structure in which the LED chip is mounted in a package body. In this case, the LED chip may emit blue light, green light, or red light, depending on a material contained therein or in combination with a fluorescent material. The LED chip may emit white light, ultraviolet light, or the like.

In addition, depending on a shape, a size, or a range of a display to be illuminated, the semiconductor light-emitting device may be configured with one or more LED chips, and an arrangement and color configuration thereof may be variously changed.

Further, the semiconductor light-emitting device may include, for example, a laser diode (LD) oscillating a laser when currents are applied to a p-n junction semiconductor diode formed by bonding a p-type semiconductor and an n-type semiconductor. An LD has strong linearity and may propagate several hundred to several thousand times farther than an LED. In addition, the LD may emit light in the same direction, differently from the LED emitting light in various directions. Accordingly, a beam angle of the LED may be about 110 to 120 degrees, whereas a beam angle of the LD may be less than 10 degrees, due to linearity of light thereof.

An intensity of light of the LD may not be reduced (directionality) even when the light moves relatively far. The light of the LD may be very clear and have a single wavelength (monochromaticity). The LD may have characteristics, such as an oscillation wavelength in a range of 300 nm to 20 μm, a maximum optical output power of about 50 W, a minimum oscillation starting current of several μA, a minimum frequency width of 50 kHz, a maximum wavelength variable range of 30 nm, and an operational lifespan of at least one hundred thousand hours.

The reflector 200 may reflect the light L of the light source 100 to the display 300. For this, the reflector 200 may be disposed on a path of light emitted by the light source 100.

The reflector 200 may have a rotational axis in a direction perpendicular to an optical axis Z of the light source 100, and rotate in a clockwise or counter-clockwise direction with respect to the light source 100. The reflector 200 may be connected to a driver 210 for rotational drive. The driver 210 may control a rotational direction and rotational speed of the reflector 200.

The driver 210 may include, for example, a rotational motor or a stepping motor, but is not limited thereto.

The reflector 200 may include a first plane 201 and a second plane 202 disposed opposite to the first plane 201, and may reflect the light L of the light source 100 through the first plane 201 and the second plane 202. In the exemplary embodiment of the present inventive concept, the reflector 200 may have a plate structure in which the first plane 201 and the second plane 202 are parallel, but is not limited thereto.

The reflector 200 may be formed of a material having superior light reflectivity, for example, a metal material. Alternatively, the first plane 201 and second plane 202 of the reflector 200, which reflects the light L of the light source 100, may be coated with a material having superior light reflectivity.

The light L reflected by the reflector 200 may be incident onto the display 300. The display 300 may include a spreading plate so that the light L is spread in a location on which the light L is incident. Light La spread on the display 300 may be represented by a movement direction of the light L. Accordingly, a viewer located on an opposite side to a plane of incidence may recognize a pattern projected by the spread light La on the display 300, and obtain information indicated by the displayed pattern.

The display 300 disclosed in the specification refers to a device which displays a pattern transmitting specific information or having aesthetic sense by using an image (including a pattern and/or a color) displayed on a surface thereof when the light L of the light source 100 is radiated thereto, or using a change in the image. Accordingly, the display 300 may be distinguished from other lighting devices used for simply supplying light to a dark place. For example, the display 300 may transmit specific information to a viewer through a visual change of an image displayed by incident light L. Here, the “viewer” refers to a person located on an opposite side to the plane of incidence and receiving information through the display 300. Accordingly, the display 300 may have not only a display function since it uses an optical pattern delivered by light projected therefrom, but also a certain level of lighting function depending on the amount of transmitted light.

In detail, the image displayed on the display 300 according to the exemplary embodiment of the present inventive concept may move the spread light La in a certain direction to direct a vehicle in which the display 300 is mounted to move in the indicated direction. In the exemplary embodiment of the present inventive concept, a visual change of the optical pattern is described only using a movement direction thereof. However, changes in colors and/or intensity of light may be alternatively used or combined. According to one embodiment of the present inventive concept, the light source 100 may be kept on when the reflector 200 rotates along one direction from a first position to a second position, and the light source 100 may be kept off when the reflector 200 rotates along an opposite direction from the second position back to the first position. According to another embodiment of the present inventive concept, the light source 100 may be kept on when the reflector 200 rotates along the one direction from the first position to the second position at a first rotational speed and the light source 100 may be kept on when the reflector 200 rotates along the opposite direction from the second position back to the first position at a second rotational speed faster than the first rotational speed.

In addition, the display 300 may be modified to have various applications. For example, the display 300 may be used in various display devices that facilitate the realization of an aesthetic sense through visual changes, as well as information delivery display devices, such as traffic lights or electric signboards.

For example, when light L having linearity, such as light from a laser, is reflected by the reflector 200 to be incident on the display 300, the light L may radially spread to occupy a predetermined area from an area of the display 300, on which the light L is incident, and radiate in an advancing direction thereof.

That is, the display 300 may be largely divided into a bright portion in which the incident light radiates and a dark portion other than the bright portion. The bright portion may be defined as a spread shape of the spread light La. Accordingly, the display 300 may visually recognize the shape of the spread light La by distinguishing it according to contrast, and display the shape of the spread light La as if a screen displays an image.

In the display 300, the location of the area on which light is incident may continuously move in at least one direction of the display 300 according to the movement of the reflector 200. That is, when the reflector 200 rotates, the location of the area of the display 300, on which the light L of the light source 100 is incident, may move, and an image of the spread light La moving in a longitudinal direction of the display 300 may be implemented.

The spread light La may implement a predetermined pattern, for example, continuously moving in one direction or moving back and forth along the display 300. In addition, such a movement pattern may repeatedly take place in predetermined cycles, which allows the spread light La to implement a certain signal.

A speed and direction of the light L moving along the display 300 may be controlled by a rotational speed and direction of the reflector 200.

The display 300 may be semitransparent or non-transparent so as to display an image by spreading the incident light.

The display 300 may be formed of a resin having translucency. For example, the display 300 may include polycarbonate (PC), polymethylmethacrylate (PMMA), acrylic, or the like. In addition, the display 300 may be formed of a glass material, but is not limited thereto.

The display 300 may contain a light-spreading material. The light-spreading material may include, for example, one or more material selected from the group consisting of SiO₂, TiO₂, and Al₂O₃.

The light-spreading material may be included in the range of, for example, about 3% to about 15%. When the light-spreading material is included less than 3%, the light L may not sufficiently spread, and thus a light-spreading effect may not be expected. In addition, when the light-spreading material is included more than 15%, the amount of light displayed to an exterior through the display 300 may be reduced, and thus light extraction efficiency may be reduced. Accordingly, it may be difficult to visually recognize the shape of the spread light La.

The display 300 may have various shapes corresponding to a lighting device in which the light source module 10 according to the exemplary embodiment of the present inventive concept is installed. In the exemplary embodiment of the present inventive concept, the display 300 may have a bar shape extending in a longitudinal direction, but is not limited thereto.

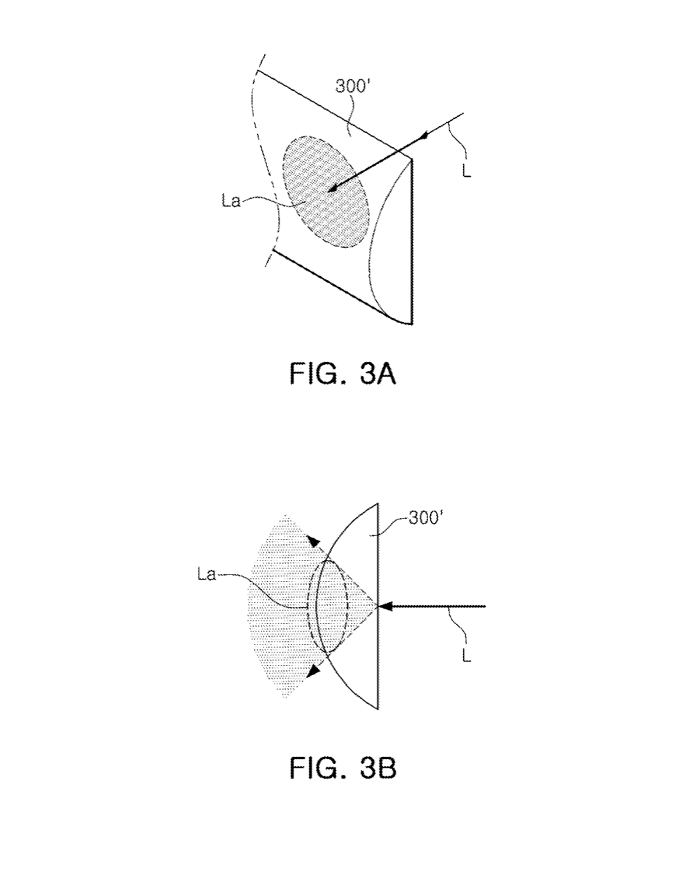

FIGS. 3A and 3B schematically illustrate a modified example of a display 300′. As illustrated in FIGS. 3A and 3B, the display 300′ may have a structure convexly protruding in a movement direction of the light L.

Since the display 300′ has a cross-sectional structure such as a convex lens, the shape of the spread light La displayed to the exterior through the display 300′ may be more enlarged.

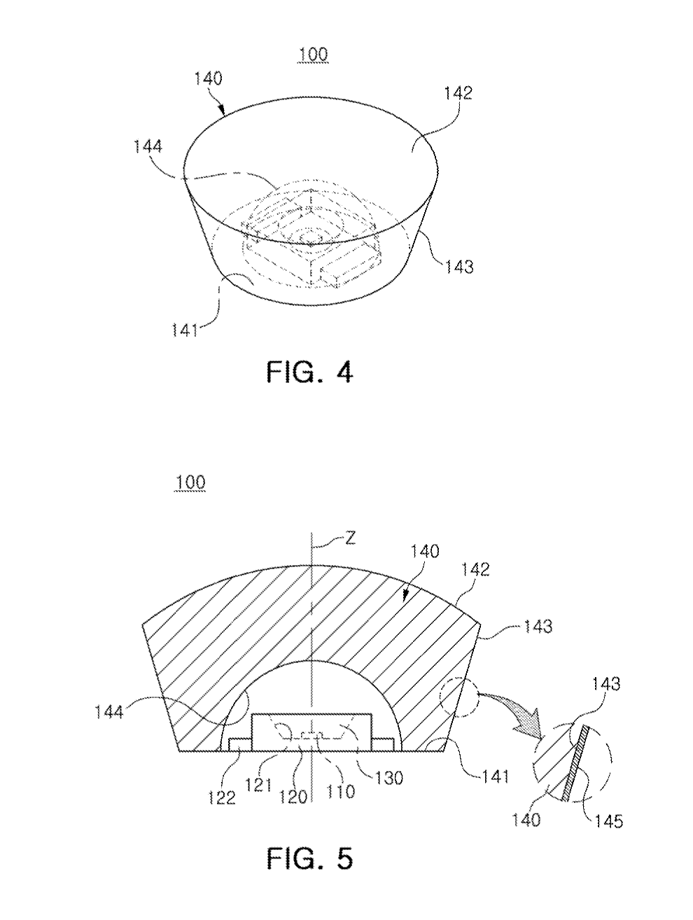

A light source 100 according to an exemplary embodiment of the present inventive concept will be described with reference to FIGS. 4 to 6.

As illustrated in FIGS. 4 and 5, the light source 100 may include a package body 120 having a reflective cup shaped recess 121, an LED chip 110 mounted in the recess 121, a wavelength conversion layer 130 filling the recess 121 and encapsulating the LED chip 110, and a lens 140 disposed on the LED chip 110.

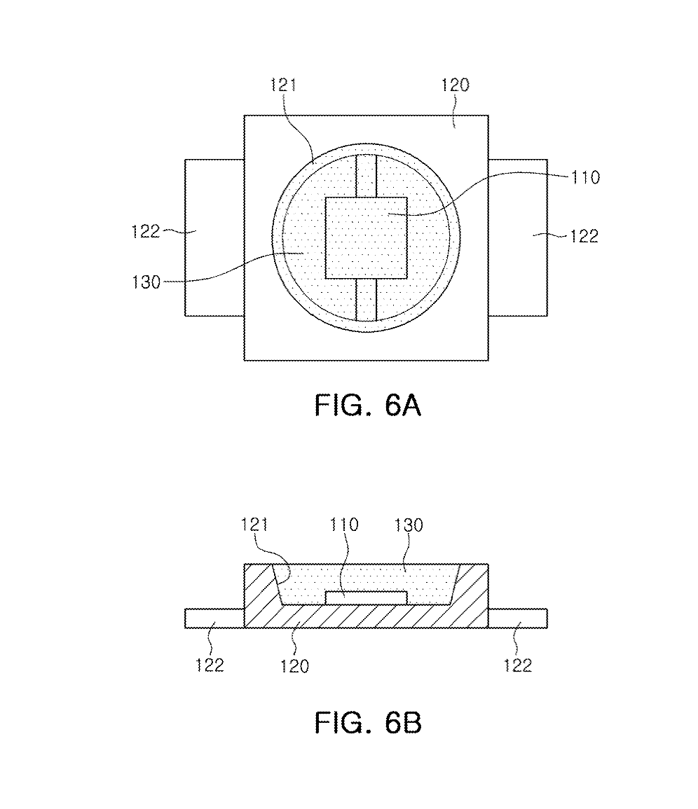

FIGS. 6A and 6B schematically illustrate the package body 120 except for the lens 140.

The package body 120 may be formed of a white molding compound having high light reflectance. Accordingly, the package body 120 may have an effect of increasing the amount of light emitted to the exterior by reflecting light emitted from the LED chip 110. The white molding compound may include a thermosetting resin-based material or a silicone resin-based material, having a high degree of heat resistance. In addition, a white pigment and filler, a curing agent, a release agent, an antioxidant, an adhesion-improving agent, or the like may be added to a thermoplastic resin-based material. In addition, the white molding compound may be formed of FR-4, CEM-3, an epoxy material, or a ceramic material. Further, the white molding compound may be formed of a metal material such as Al.

The package body 120 may include a lead frame 122 for forming an electrical connection to an external power source.

The lead frame 122 may be formed of a material having excellent electrical conductivity, such as Al or Cu. When the package body 120 is formed of a metal material, an insulating material may be interposed between the package body 120 and the lead frame 122.

In the recess 121 of the package body 120, the lead frame 122 may be exposed on a bottom surface on which the LED chip 110 is mounted. In addition, the LED chip 110 may be electrically connected to the exposed lead frame 122.

An area of a cross-section of the recess 121 exposed on a top surface of the package body 120 may be greater than an area of the bottom surface of the recess 121. Here, the cross-section of the recess 121 exposed on a top surface of the package body 120 may defined as a light-emitting plane of the package body 120.

Meanwhile, the LED chip 110 may be encapsulated by the wavelength conversion layer 130 formed in the recess 121 of the package body 120. The wavelength conversion layer 130 may include a wavelength-converting material.

The wavelength-converting material may include, for example, at least one phosphor excited by light generated from the LED chip 110 and emitting light having a different wavelength. Through the wavelength-converting material, various colors of light including white light may be emitted.

For example, when the LED chip 110 emits blue light, white light may be emitted by mixing phosphors having yellow, green, and red or orange colors. Otherwise, the LED chip 110 may be configured to include at least one LED chip emitting purple, blue, green, red, or infrared light. In this case, the LED chip 110 may control color rendering index (CRI) in the range from a level of a sodium (Na) lamp (CRI 40), to a level of solar light (CRI 100), and generate a variety of levels of white light having a color temperature in the range of about 2000 to 20000K. In addition, the LED chip 110 may emit visible light having a purple, blue, green, red, or orange color, or infrared light as needed, and control the color according to an environment or mood. In addition, the LED chip 110 may emit light having a specific wavelength to promote plant growth.

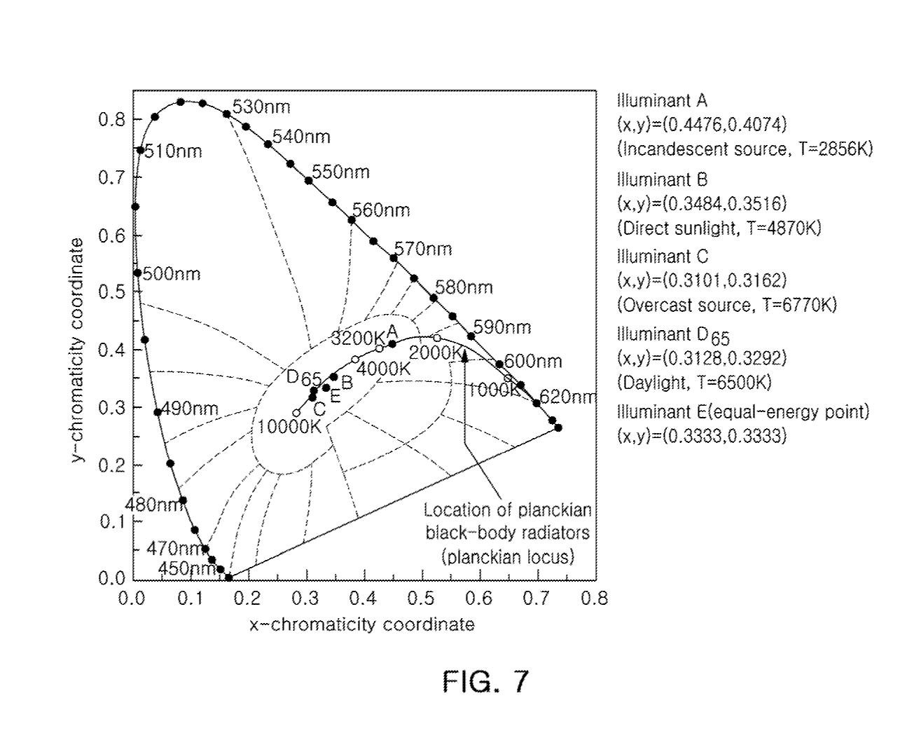

White light formed by combination of a blue LED, and yellow, green, and red phosphors and/or green and red LEDs may have two or more peak wavelengths, and may be located on the line connecting (x, y) coordinates of (0.4476, 0.4074), (0.3484, 0.3516), (0.3101, 0.3162), (0.3128, 0.3292), (0.3333, 0.3333) in the CIE 1931 coordinate system illustrated in FIG. 7. Otherwise, the white light may be located in a zone surrounded by the line and a black body radiation spectrum. The color temperature of the white light may corresponds to 2000 to 20000K.

The phosphor may have a compositional formula and color as follows.

Oxide group: yellow and green Y₃Al₅O₁₂:Ce, Tb₃Al₅O₁₂:Ce, Lu₃Al₅O₁₂:Ce

Silicate group: yellow and green (Ba,Sr)₂SiO₄:Eu, yellow and orange (Ba,Sr)₃SiO₅:Ce

Nitride group: green β-SiAlON:Eu, yellow La₃Si₆N₁₁:Ce, orange α-SiAlON:Eu, red CaAlSiN³:Eu, Sr₂Si₅N₈:Eu, SrSiAl₄N₇:Eu

Fluoride group: KSF-based red K₂SiF₆:Mn4+

Basically, the composition of the phosphor may be consistent with stoichiometry, and each element may be substituted by another element in each group of the periodic table. For example, strontium (Sr) may be substituted by Ba, Ca, Mg, and the like in the alkaline earth (II) group, and Y may be substituted by Tb, Lu, Sc, Gd, and the like in the lanthanide group. In addition, Eu, an activator, may be substituted by Ce, Tb, Pr, Er, Yb, or the like according to a preferred energy level. The activator may be used alone, or a coactivator may be further included in order to change characteristics.

In addition, a material such as a quantum dot (QD) may be used as an alternative material for the phosphor, and the phosphor and the QD may be used mixed or QA alone.

The QD may have a structure consisting of a core (diameter of about 3 to 10 nm), such as CdSe and InP, a shell (thickness of about 0.5 to 2 nm), such as ZnS and ZnSe, and a ligand for stabilizing the core and shell, and implement a variety of colors according to sizes thereof.

The lens 140 may be disposed on the LED chip 110 and control a beam angle of light emitted from the LED chip 110. For example, the lens 140 may include a condensing lens focusing light of the LED chip 110 on a specific area.

Referring back to FIGS. 4 and 5, the lens 140 may include a first plane 141 having a groove 144 accommodating the package body 120 in a center portion thereof, a second plane 142 disposed on the first plane 141 and emitting light of the LED chip 110 to the exterior, and a third plane 143 connecting edges of the first plane 141 and second plane 142 and reflecting the light to the second plane 142.

The first plane 141 may correspond to a bottom surface of the lens 140, and have a flat circular-shaped cross-sectional structure overall. The first plane 141 may include the groove 144 recessed in a light emitting direction in the center portion through which an optical axis Z of the LED chip 110 passes. The groove 144 may have a structure rotationally symmetrical with respect to the optical axis Z, and a surface thereof may be defined as a plane of incidence on which light of the LED chip 110 is incident. Accordingly, the light generated in the LED chip 110 may pass through the groove 144 to proceed to the inside of the lens 140.

The groove 144 may be open to the exterior through the first plane 141. Embossings for scattering light may be formed on a surface of the groove 144. The embossings may be formed, for example, by corroding the surface of the groove 144.

The second plane 142 may be disposed opposite to the first plane 141. The second plane 142 is a light-emitting plane in which light entered through the groove 144 is emitted to the exterior, and corresponds to an upper surface of the lens 140. The second plane 142 may be bulged upwardly, that is, in a light-emitting direction, in the form of a dome. In addition, the second plane 142 may include embossings for scattering light.

In the exemplary embodiment of the present inventive concept, the second plane 142 has a structure bulged upwardly in the form of a dome, but is not limited thereto. For example, the second plane 142 may have a structure recessed toward the first plane 141. In addition, the second plane 142 may have a flat structure.

The third plane 143 may be upwardly extended from an edge of the first plane 141 and connected to an edge of the second plane 142, and correspond to a side surface of the lens 140. The third plane 143 may have an inclined structure forming an obtuse angle with respect to the first plane 141. Accordingly, the lens 140 may have a structure whose cross-sectional area increases from the first plane 141 toward the second plane 142, that is, in an upward direction.

The third plane 143 may reflect light incident through the groove 144 to the second plane 142. In addition, third plane 143 may control a light distribution area by changing a slope formed with respect to the first plane 141.

Meanwhile, the lens 140 may further include a reflection layer 145 covering the third plane 143. The reflection layer 145 may serve to improve light reflection efficiency. The reflection layer 145 may be formed of thin film-type metal layer. The reflection layer 145 may include, for example, Al, Cu, or Ag, and be attached to the third plane 143 by coating, deposition, or an adhesive material. In addition, the reflection layer 145 may be formed of a resin containing light-reflecting material.

The lens 140 may be formed of a resin having translucency. For example, the lens 140 may include polycarbonate (PC), polymethylmethacrylate (PMMA), acrylic, or the like. In addition, the lens 140 may be formed of glass, but is not limited thereto.

In addition, the lens 140 may include a light-reflecting material. The light-reflecting material may include, for example, at least one selected from the group consisting of SiO₂, TiO₂, and Al₂O₃.

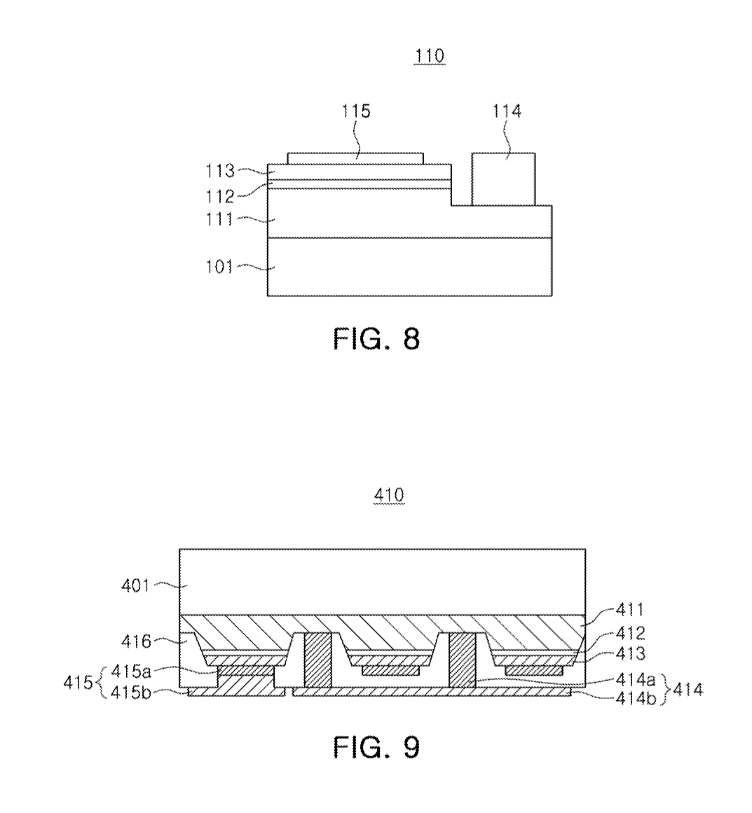

LED chips according to various exemplary embodiments of the present inventive concept will be described with reference to FIGS. 8 to 10. FIGS. 8 to 10 are cross-sectional views illustrating various examples of an LED chip utilized as a light source.

Referring to FIG. 8, an LED chip 110 may include a first conductivity-type semiconductor layer 111, an active layer 112, and a second conductivity-type semiconductor layer 113, sequentially stacked on a growth substrate 101.

The first conductivity-type semiconductor layer 111 stacked on the growth substrate 101 may be an n-type nitride semiconductor layer doped with n-type impurities. In addition, the second conductivity-type semiconductor layer 113 may be a p-type nitride semiconductor layer doped with p-type impurities. However, in some embodiments, the first and second conductivity-type semiconductor layers 111 and 113 may be inversely stacked. The first and second conductivity-type semiconductor layers 111 and 113 may have a compositional formula of AlₓIn_{y}Ga_{(1-x-y)}N (wherein, 0≦x<1, 0≦y−1, and O≦x+y<1), for example, GaN, AlGaN, InGaN, and AlInGaN.

The active layer 112 disposed between the first and second conductivity-type semiconductor layers 111 and 113 may emit light having a predetermined level of energy generated by electron-hole recombination. The active layer 112 may include a material having a smaller energy bandgap than the first and second conductivity type semiconductor layers 111 and 113. For example, when the first and second conductivity type semiconductor layers 111 and 113 are GaN-based compound semiconductors, the active layer 112 may include an InGaN-based compound semiconductor having a smaller energy bandgap than GaN. Further, the active layer 112 may have a multiple quantum well (MQW) structure, for example, an InGaN/GaN structure, in which quantum well layers and quantum barrier layers are alternately stacked. However, the active layer 112 may not be limited thereto, and may have a single quantum well (SQW) structure.

The LED chip 110 may include first and second electrode pads 114 and 115 electrically connected to the first and second conductivity type semiconductor layers 111 and 113, respectively. The first and second electrode pads 114 and 115 may be exposed and disposed in the same direction. In addition, the first and second electrode pads 114 and 115 may be electrically connected to a substrate by a wire bonding method or a flip-chip bonding method.

An LED chip 410 illustrated in FIG. 9 may include a semiconductor laminate formed on the growth substrate 401. The semiconductor laminate may include a first conductivity-type semiconductor layer 411, an active layer 412, and a second conductivity-type semiconductor layer 413.

The LED chip 410 may include first and second electrode pads 414 and 415 respectively connected to the first and second conductivity type semiconductor layer 411 and 413.

The first electrode pad 414 may include a conductive via 414a passing through the second conductivity-type semiconductor layer 413 and the active layer 412 to be connected to the first conductivity-type semiconductor layer 411, and an electrode extension portion 414b connected to the conductive via 414a. The conductive via 414a may be surrounded by an insulating layer 416 to be electrically isolated from the active layer 412 and the second conductivity-type semiconductor layer 413. The conductive via 414a may be disposed on an area where the semiconductor laminate is etched. The number, shape, or pitch of the conductive via 414a, or a contact area with the first conductivity-type semiconductor layer 411 may be appropriately designed to reduce contact resistance. In addition, the conductive via 414a may be arranged in rows and columns on the semiconductor laminate to improve current flow.

The second electrode pad 415 may include an ohmic contact layer 415a and an electrode extension portion 415b on the second conductivity-type semiconductor layer 413.

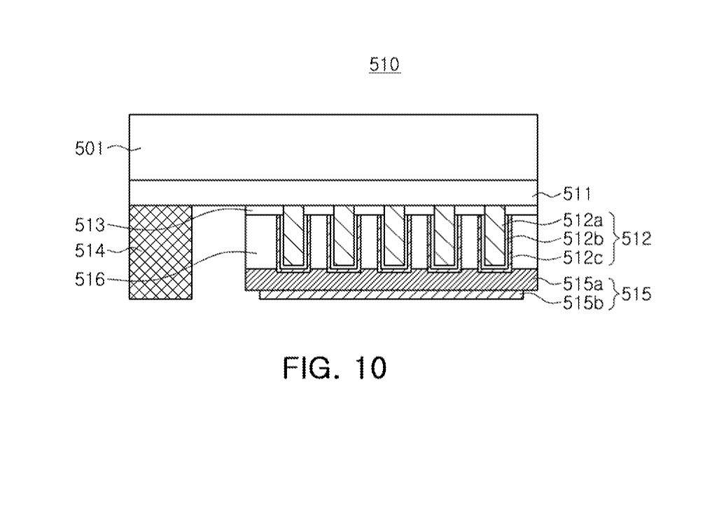

An LED chip 510 illustrated in FIG. 10 may include a growth substrate 501, a first conductivity-type semiconductor base layer 511 formed on the growth substrate 501, and a plurality of light-emitting nanostructures 512 formed on the first conductivity-type semiconductor base layer 511. In addition, the LED chip 510 may further include an insulating layer 513 and a filling portion 516.

The light-emitting nanostructure 512 may include a first conductivity-type semiconductor core 512a, and an active layer 512b and a second conductivity-type semiconductor layer 512c sequentially stacked on a surface of the first conductivity-type semiconductor core 512a as a shell layer. In the exemplary embodiment, the light-emitting nanostructure 512 is illustrated as having a core-shell structure. However, the light-emitting nanostructure 512 is not limited thereto, and may have a different structure, for example, a pyramidal structure.

The first conductivity-type semiconductor base layer 511 may provide a growth surface for the light-emitting nanostructure 512. The insulating layer 513 may provide an open area for the growth of the light-emitting nanostructure 512, and may be a dielectric material, such as SiO₂ or SiNₓ. The filling portion 516 may structurally stabilize the light-emitting nanostructure 512, and may function to transmit or reflect light. When the filling portion 516 includes a light-transmitting material, the filling portion 516 may be formed of a transparent material, such as SiO₂, SiNx, an elastic resin, silicone, an epoxy resin, a polymer, or plastic. As needed, when the filling portion 516 includes a reflective material, the filling portion 516 may be formed of a polymer material such as polyphthalamide (PPA), and a highly reflective metal powder or a ceramic powder. The highly reflective ceramic powder may be at least one selected from the group consisting of TiO₂, Al₂O₃, Nb₂O₅, Al₂O₃, and ZnO. The highly reflective metal may be aluminum (Al) or silver (Ag).

The second electrode pad 515 may be disposed on a bottom surface of the light-emitting nanostructure 512. The first electrode pad 514 may be disposed on an exposed surface of the first conductivity-type semiconductor base layer 511, and the second electrode pad 515 may include an ohmic contact layer 515a and an electrode extension portion 515b formed under the light-emitting nanostructure 512 and the filling portion 516. Otherwise, the ohmic contact layer 515a and the electrode extension portion 515b may be integrally formed.

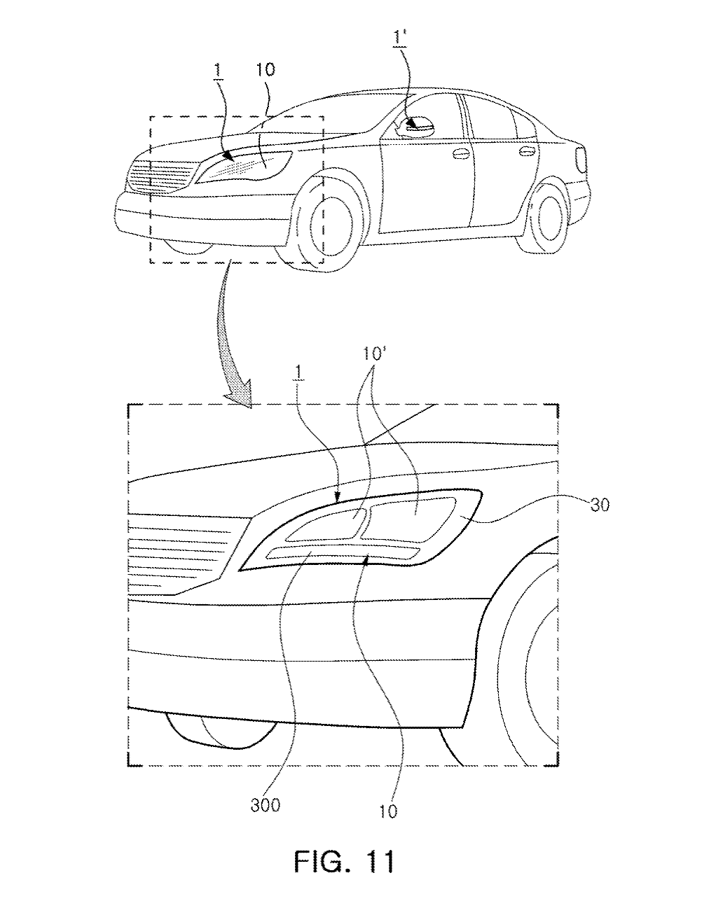

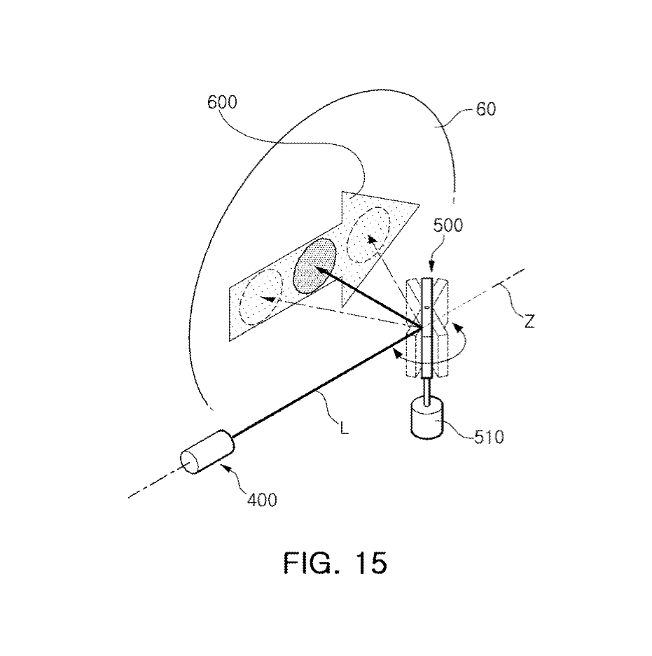

Lighting devices including a light source module according to various exemplary embodiments of the present inventive concept will be described with reference to FIGS. 11 to 19.

FIGS. 11 to 13 schematically illustrate a lighting device according to an exemplary embodiment of the present inventive concept.

Referring to FIGS. 11 to 13, a lighting device 1 according to an exemplary embodiment of the present inventive concept may be a vehicle headlamp, and a light source module 10 may be used as a turn signal lamp for indicating a direction of travel.

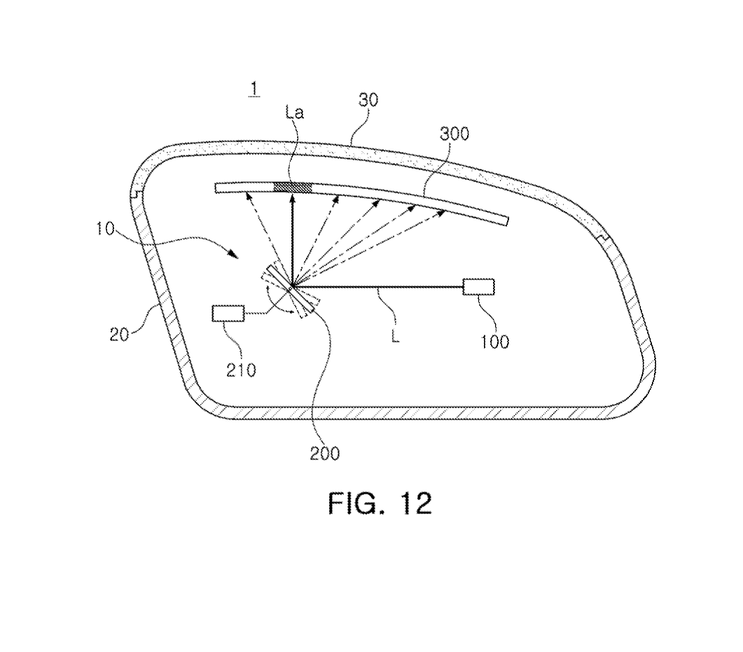

As illustrated in FIGS. 11 and 12, the lighting device 1 may include the light source module 10, a housing 20, and a cover 30. The light source module 10 may include a light source module 10′ for a headlamp and a light source module 10 for a turn signal lamp. Hereinafter, the light source module 10 for a turn signal lamp will only be described.

The light source module 10 may include a light source 100, a reflector 200, and a display 300.

The light source 100 may emit light L having a predetermined wavelength by power supplied from an external device. The light source may include, for example, a semiconductor light-emitting device emitting light having linearity and high luminance. The semiconductor light-emitting device may include, for example, a laser or an LED.

The reflector 200 may be disposed on a path of light L of the light source 100 and reflect the light L of the light source 100 to the display 300. The reflector 200 may be connected to a driver 210 and rotated in a clockwise or counter-clockwise direction with respect to the light source 100.

The light L reflected by the reflector 200 may be incident on the display 300, and the display 300 may spread the light L in an area on which the light L is incident. In addition, the display 300 may emit the spread light La in an advancing direction of the light L such that the shape of the spread light La is displayed through the display 300.

In the display 300, a location of the area on which the light L is incident may be continuously move in at least one direction of the display 300 according to the movement of the reflector 200. That is, when the reflector 200 rotates, the location of the area of the display 300, on which the light L of the light source 100 is incident, may move and an image of the spread light La moving in a longitudinal direction of the display 300 may be implemented.

The spread light La may implement a predetermined pattern, for example, continuously moving in one direction or moving back and forth along the display 300. In addition, such a movement pattern may repeatedly take place in predetermined cycles, which allows the spread light La to implement a certain signal.

A speed and direction of the light L moving along the display 300 may be controlled by a rotational speed and direction of the reflector 200.

A basic configuration and structure of the light source module 10 may be substantially the same as the basic configuration and structure of the light source module 10 described with reference to FIGS. 1 to 10. Accordingly, detailed descriptions thereof will be omitted.

The housing 20 may accommodate and support the light source module 10 therein. The housing 20 may be, for example, a plastic object formed by injection molding.

Various components configuring the light source module 10′ for a headlamp, not illustrated in the drawing, as well as the light source module 10 for a turn signal lamp may be installed in the housing 20.

The cover 30 may be installed in the housing 20 and cover the light source module 10 to protect the light source module 10.

The cover 30 may be formed of a resin having translucency. For example, the cover 30 may include polycarbonate (PC), polymethylmethacrylate (PMMA), acrylic, or the like.

The display 300 disposed to face the cover 30 may be exposed to an exterior through the cover 30. Accordingly, the image of the spread light La moving, implemented on the display 300 may be displayed to the exterior through the cover 30. Only the display 300 among the components configuring the light source module 10 may be exposed to the exterior through the cover 30.

For example, when a car driver operates a left-turn or right-turn signal, alight source 100 of a corresponding turn signal lamp may be operated by the operation signal to emit the light L. The emitted light L may be reflected to a display 300 by the reflector 200. At this time, the reflector 200 may be rotated in a direction corresponding to the operation signal and move the area of the display 300, on which the light L is incident.

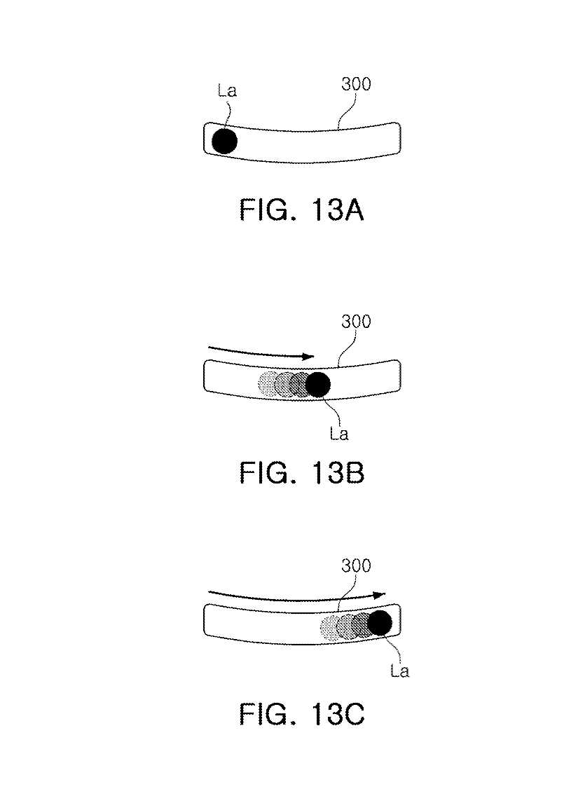

Accordingly, as illustrated in FIGS. 13A to 13C, an image of the spread light La moving in a longitudinal direction of the display 300 may be implemented in the display 300.

Such an image of the spread light La moving may repeatedly shown in predetermined cycles, which allows the spread light La to implement a certain signal, the left-turn signal or a light-turn signal. Accordingly, other drivers may visually recognize the signal, such as the left-turn signal or a light-turn signal, displayed to the exterior through the cover 30.

Accordingly, since the vehicle headlamp including the light source module according to the exemplary embodiment of the present inventive concept uses a single light source, it has an advantage of low cost compared to a normal vehicle headlamp including a plurality of LEDs. In addition, when an LED failure occurs, the vehicle headlamp including the light source module according to the exemplary embodiment of the present inventive concept may be easily replaced, and thus may be advantageous in terms of maintenance and repair.

In addition, since an image of light moving is implemented by a rotating reflector, the vehicle headlamp including the light source module according to the exemplary embodiment of the present inventive concept may implement a visually more natural movement than a normal vehicle headlamp that is sequentially lit.

According to the exemplary embodiment of the present inventive concept, the lighting device 1 is a turn signal lamp installed in a headlamp of a car, but is not limited thereto. For example, as illustrated in FIG. 11, a lighting device 1′ may include a turn signal lamp installed in a side mirror of a car. That is, the lighting device 1′ may be installed in the side mirror of a car and serve to denote a moving direction on left and right sides of the car.

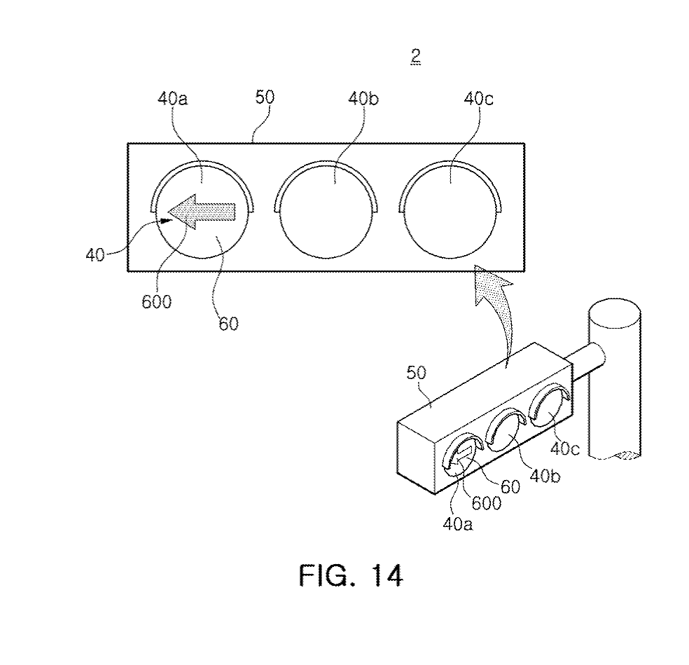

FIGS. 14 to 16 schematically illustrate a lighting device according to another exemplary embodiment of the present inventive concept.

Referring to FIGS. 14 to 16, a lighting device 2 may be, for example, a traffic light and include a light source module 40, a housing 50, and a cover 60.

The light source module 40 may turn on a red signal 40b, a green signal 40c, and a left-turn signal 40a. Hereinafter, a light source module 40 turning on the left-turn signal 40a will be described.

The light source module 40 may include a light source 400, a reflector 500, and a display 600.

The light source 400 may emit light L having a predetermined wavelength by power supplied from an external device. The light source 400 may include, for example, a semiconductor light-emitting device emitting light having linearity and high luminance. The semiconductor light-emitting device may include, for example, a laser or an LED.

The reflector 500 may be disposed on a path of light L of the light source 400 and reflect the light L of the light source 400 to the display 600. The reflector 500 may be connected to a driver 510 and rotated in a clockwise or counter-clockwise direction with respect to the light source 400.

The light L reflected by the reflector 500 may be incident on the display 600, and the display 600 may spread the light L in an area on which the light L is incident. In addition, the display 600 may emit the spread light La in an advancing direction of the light L such that the shape of the spread light La is displayed through the display 600.

A basic configuration and structure of the light source module 40 may be substantially the same as the basic configuration and structure of the light source module 10 described with reference to FIGS. 1 to 10. Accordingly, detailed descriptions thereof will be omitted.

The housing 50 may accommodate and support the light source module 40 therein. The housing 50 may be, for example, a plastic object formed by injection molding.

The cover 60 may be installed in the housing 50 and cover the light source module 40 to protect the light source module 40.

The cover 60 may be formed of a resin having translucency. For example, the cover 60 may include polycarbonate (PC), polymethylmethacrylate (PMMA), acrylic, or the like.

The cover 60 may partially include the display 600 of the light source module 40. That is, the cover 60 and the display 600 may be integrally formed, and the display 600 may occupy a portion of the cover 60. Accordingly, an image of the spread light La moving, implemented on the display 600, may be directly displayed to an exterior through the display 600.

For example, when a left-turn signal is lit, the light source 400 may be operated to emit the light L. The emitted light L may be reflected to the display 600 by the reflector 500. At this time, the reflector 500 may be rotated in a direction corresponding to the left-turn signal, and move a position of the area of the display 600, on which the light L is incident.

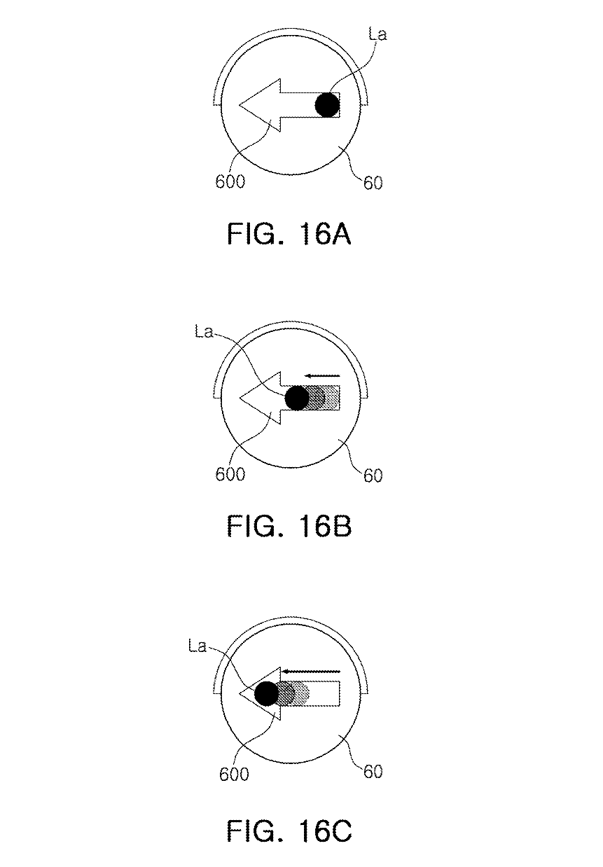

Accordingly, as illustrated in FIGS. 16A to 16C, the display 600 may implement the image of the spread light La continuously moving to the left in a longitudinal direction of the display 600.

Such an image of the spread light La moving may repeatedly shown in predetermined cycles, which allows the spread light La to implement a left-turn signal. Accordingly, a driver may visually recognize the left-turn signal displayed to the exterior through the display 600 included in the cover 60.

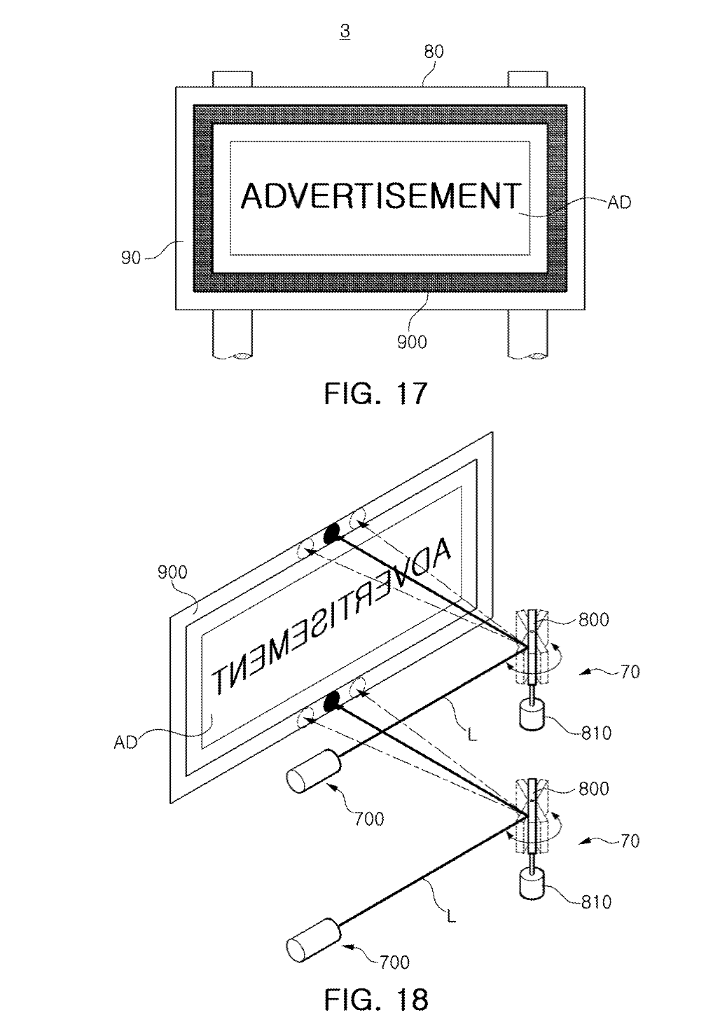

FIGS. 17 to 19 schematically illustrate a lighting device 3 according to another exemplary embodiment of the present inventive concept.

Referring to FIGS. 17 to 19, a lighting device 3 may be, for example, an electric signboard and include a light source module 70, a housing 80, and a cover 90.

The light source module 70 may include, for example, a light source 700, a reflector 800, and a display 900 so as to light an advertisement sign AD for advertisement.

The light source 700 may emit light L having a predetermined wavelength by power supplied from an external device. The light source 700 may include, for example, a semiconductor light-emitting device emitting light having linearity and high luminance. The semiconductor light-emitting device may include, for example, a laser or an LED.

The reflector 800 may be disposed on a path of light L of the light source 700 and reflect the light L of the light source 700 to the display 900. The reflector 800 may be connected to a driver 810 and rotated in a clockwise or counter-clockwise direction with respect to the light source 700.

The light L reflected by the reflector 800 may be incident on the display 900, and the display 900 may spread the light L in an area on which the light L is incident. In addition, the display 900 may emit the spread light La in an advancing direction of the light L such that the shape of the spread light La is displayed through the display 900.

In the exemplary embodiment of the present inventive concept, the display 900 may be disposed around the advertisement sign AD disposed in a center portion thereof, but is not limited thereto. The arrangement of the display 900 may be variously changed. In addition, the advertisement sign AD may be directly implemented through the arrangement of the display 900.

A basic configuration and structure of the light source module 70 may be substantially the same as the basic configuration and structure of the light source module 10 described with reference to FIGS. 1 to 10. Accordingly, detailed descriptions thereof will be omitted.

The housing 80 may accommodate and support the light source module 70 therein. The housing 80 may be, for example, a plastic object formed by injection molding.

The cover 90 may be installed in the housing 80 and cover the light source module 70 to protect the light source module 70.

The cover 90 may be formed of a resin having translucency. For example, the cover 90 may include polycarbonate (PC), polymethylmethacrylate (PMMA), acrylic, or the like.

The cover 90 may partially include the display 900 of the light source module 70. That is, the cover 90 and the display 900 may be integrally formed, and the display 900 may occupy a portion of the cover 90. Accordingly, an image of the spread light La moving, implemented on the display 900, may be directly displayed to an exterior through the display 900.

For example, when a user operates the electric signboard, the light source 700 may be operated to emit the light L. The emitted light L may be reflected to the display 900 by the reflector 800. At this time, the reflector 800 may be rotated and move a position of the area of the display 900, on which the light L is incident.

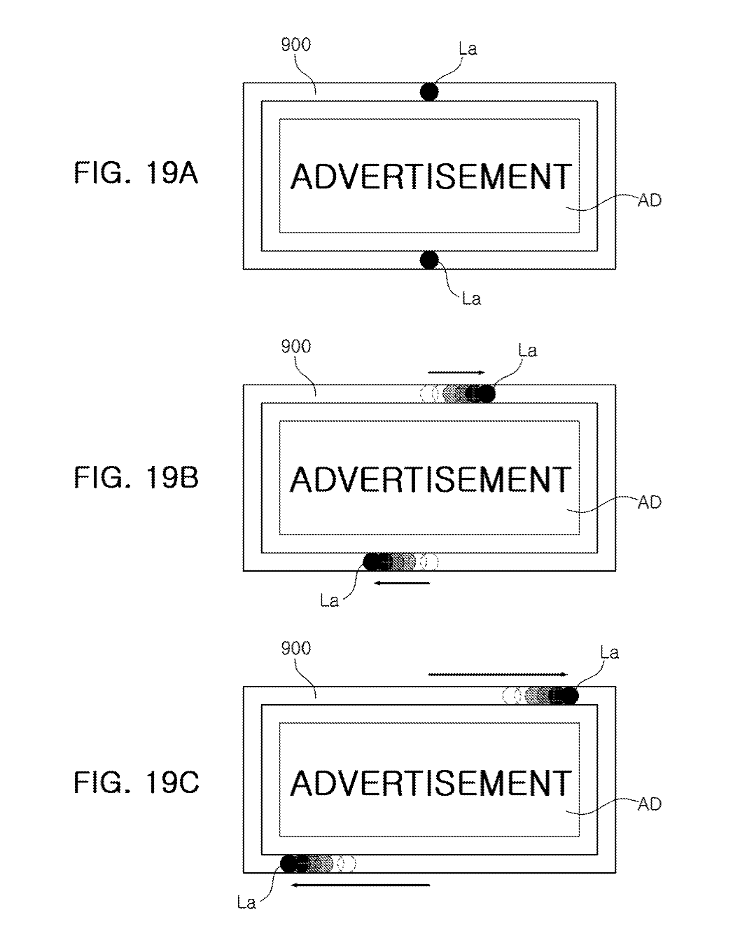

Accordingly, as illustrated in FIGS. 19A to 19C, the display 900 may implement the image of the spread light La continuously moving in a longitudinal direction of the display 900.

Such an image of the spread light La moving may repeatedly shown in predetermined cycles, which allows the spread light La to implement a left-turn signal, the left-turn signal or a light-turn signal. Accordingly, the user may visually recognize the signal displayed to the exterior through the cover 90. Further, an advertising effect may double by increasing a visual effect through a change in motion such as rotation.

As set forth above, according to the exemplary embodiments of the present inventive concept, a light source module and a lighting device capable of overcoming problems generated by normal lighting devices using a plurality of LEDs, may be provided.

While exemplary embodiments have been shown and described above, it will be apparent to those skilled in the art that modifications and variations could be made without departing from the scope of the invention as defined by the appended claims.

What is claimed is:

1. A light source module, comprising:
a light source;
a reflector reflecting light emitted by the light source; and
a display on which the light reflected by the reflector is incident, spreading the light in a location on which the light is incident,
wherein a position of the location of the display on which light is incident, continuously moves in at least one direction according to a motion of the reflector.

2. The light source module of claim 1, wherein the spread light has a pattern of moving in a direction along the display.

3. The light source module of claim 2, wherein the reflector implements a predetermined signal by allowing the display to repeatedly display the pattern in predetermined cycles.

4. The light source module of claim 2, wherein a speed and a direction of the light, of the light source, moving along the display are controlled by a rotational speed and a rotational direction of the reflector.

5. The light source module of claim 1, wherein the display has a structure convexly protruding in an advancing direction of the light.

6. The light source module of claim 1, wherein the display is semitransparent or non-transparent and includes a light-spreading material.

7. The light source module claim 1, wherein the reflector has a rotational axis in a direction perpendicular to an optical axis of the light source and rotates in a clockwise or counter-clockwise direction with respect to the light source.

8. The light source module claim 1, wherein the reflector includes a first plane and a second plane disposed opposite to the first plane and reflects the light emitted by the light source through the first plane and the second plane.

9. The light source module of claim 1, wherein the light source includes a semiconductor light-emitting device emitting light having linearity.

10. The light source module of claim 1, wherein the light source includes a package body having a recess, an LED chip mounted in the recess, a wavelength conversion layer filling the recess and encapsulating the LED chip, and a lens disposed on the LED chip.

11. The light source module of claim 1, further comprising a driver driving the reflector to rotate.

12. The light source module of claim 1, wherein the light source is the only light source emitting the light that is reflected by the reflector.

13. A light source module, comprising:
a light source emitting light having linearity;
a display on which the light emitted by the light source is incident, spreading the light in a location on which the light is incident; and
a reflector disposed on a path of light to have a rotational structure and reflecting the light emitted by the light source to the display,
wherein a motion of the reflector is controlled to implement a pattern of an image in which the light incident on the display moves in at least one direction along the display.

14. The light source module of claim 13, wherein a moving pattern of the light moving along the display is repeatedly displayed in predetermined cycles, and the cycle, a moving speed, and a moving direction are controlled by a rotational speed and a rotational direction of the reflector.

15. The light source module of claim 13, wherein the light source is the only light source emitting the light that is reflected by the reflector.

16. A lighting device, comprising:
a light source module;
a housing accommodating the light source module therein; and
a cover installed on the housing and covering the light source module,
wherein the light source module is the light source module of claim 1.

17. The lighting device of claim 16, wherein the cover partially includes a display of the light source module.

18. A light source module, comprising:
a display including a plurality of regions arranged in one direction; and
a rotatable reflector receiving light emitted by a single light source, and reflecting the received light to the display,
wherein the plurality of regions of the display are sequentially illuminated along the one direction by the reflected light in accordance with rotation of the rotatable reflector.

19. The light source module of claim 18, wherein each of the plurality of regions spreads the reflected light incident thereto.

20. The light source module of claim 18, wherein a moving pattern of the light moving along the display is repeatedly displayed in predetermined cycles, and the cycle, a moving speed, and a moving direction are controlled by a rotational speed and a rotational direction of the reflector.
